(19) United States
(12) Patent Application Publication
(10) Pub. No.: US 2013/0019809 A1
(43) Pub. Date: Jan. 24, 2013

(54) WATER CONTAINER WITH MECHANISMS FOR CIRCULATING AND FILTERING WATER

(71) Applicants: Scott D. McCallum, Reno, NV (US); Daniel S. McCallum, Portland, OR (US)

(72) Inventors: Scott D. McCallum, Reno, NV (US); Daniel S. McCallum, Portland, OR (US)

(21) Appl. No.: 13/552,504

(22) Filed: Jul. 18, 2012

Related U.S. Application Data
(60) Provisional application No. 61/509,072, filed on Jul. 18, 2011.

(51) Int. Cl. A01K 7/06; B01D 35/02; A01K 7/00

(52) U.S. Cl. 119/75; 119/74; 210/263; 210/251; 210/259; 210/143

(57) ABSTRACT

Disclosed herein are representative embodiments of methods, apparatus, and systems related to water containers for household pets that have a mechanism for circulating water. For example, one embodiment disclosed herein is a water container for pets comprising: a bowl region on an upper surface of the water container, the bowl region comprising one or more apertures in fluid communication with an interior region of the water container; a pump outlet region on the upper surface of the water container, the pump outlet region comprising a pump outlet aperture, the pump outlet region being located adjacent to the bowl region and joined to the bowl region by a channel configured to transport fluid from the pump output aperture into the bowl region; and a water circulating system, the water circulating system comprising a pump configured to pump water from the interior region of the water container to the pump outlet aperture.

### CROSS-REFERENCE TO RELATED APPLICATIONS

This application claims the benefit of U.S. Provisional Application 61/509,072 filed on Jul. 18, 2011, and entitled “WATER CONTAINER WITH MECHANISMS FOR CIRCULATING AND FILTERING WATER,” which is hereby incorporated herein by reference.

### FIELD

This application relates to water containers for pets. In particular, this application relates to water containers that have a mechanism for circulating and/or filtering water.

### SUMMARY

Disclosed below are representative embodiments of methods, apparatus, and systems related to water containers for household pets that have a mechanism for circulating and/or filtering water. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used alone or in various combinations and subcombinations with one another.

An exemplary embodiment of a water container for pets comprises a main body having an upper surface, a lower surface, and an interior region between the upper surface and the lower surface. A bowl region is on an upper surface of the water container and comprises one or more apertures in fluid communication with the interior region, a pump outlet region, and a water circulating system. The pump outlet region is on the upper surface of the water container and comprises a pump outlet aperture. The pump outlet region is located adjacent to the bowl region and is joined to the bowl region by a channel configured to transport fluid from the pump output aperture into the bowl region. The water circulating system comprises a pump configured to pump water from the interior region of the water container to the pump outlet aperture and is configured to automatically deactivate when a volume of water in the interior region of the water container is insufficient to circulate using the water circulating system.

In some embodiments, the water circulating system can be selectively powered by two or more power sources, with one of the power sources being a solar power source. In some embodiments, the pump can comprise a DC pump. In some embodiments, the water circulating system can comprise one or more sensors configured to detect a speed and/or direction of the pump, and a controller configured to receive speed and/or direction data from the sensors and to selectively deactivate the pump based at least in part on the speed and/or direction data. In some embodiments, the water container can include a water filtration system that comprises one or more ion-exchange resin elements and/or other filtration mechanisms. In some of embodiments, the water container can include a gravity-based water filtration system positioned below the bowl region, wherein the gravity-based water filtration system is configured to allow water to percolate through the gravity-based water filtration system via gravity without being forced by a pump. In some embodiments, the water container can include a first RF ID device, such as an RF ID transmitter, configured to activate the water circulation system when a second RF ID device, such a passive RF ID tag on a pet collar, comes within a predetermined range of the first RF ID device.

Another exemplary embodiment of a water container for pets includes a water circulating system comprising a DC pump. In some embodiments, an input port of the DC pump is oriented so that the input port faces toward a bottom of the water container, and the water circulating system is configured to automatically deactivate when the input port is not submerged in water. In some embodiments, the water circulating system is selectively powered by two or more power sources, one of the power sources being a solar power source. In some embodiments, the water container further comprises one or more sensors configured to detect a speed of the DC pump, and a controller configured to receive speed data from the sensors and to selectively deactivate the DC pump based at least in part on the speed data. In some embodiments, the water container further comprises a first RF ID device configured to activate the DC pump when a second RF ID device comes within a predetermined range of the first RF ID device.

Another exemplary embodiment of a water container for pets comprises a water circulating system that is selectively powered by two or more power sources that are simultaneously coupled to the water container. In some embodiments, one of the two or more power sources comprises a solar power source and another of the two or more power sources comprise an AC/DC converter or a DC adapter.

An exemplary system disclosed herein comprises a first power source, a second power source, and a switch configured to receive power from the first and second power sources and to selectively route power from a selected one of the first or second power sources to a water circulating system of a water container for pets. In some embodiments, the switch is configured to selectively route the power based on a voltage level of power from at least one of the first power source or the second power source. In some embodiments, the power routed to the water circulating system is DC power. In some embodiments, at least one of the first power source or the second power source comprises one or more solar cells.

Another exemplary water container for pets comprises a water filtration system that comprises one or more ion-exchange resin elements. In some embodiments, the water filtration system further comprises one or more of carbon elements, a UV filter, sponge filter, and/or a filter cover comprising one or more apertures configured to filter particles having a selected diameter. In some embodiments, water percolates through the filtration system via gravity without being forced by a pump.

Another exemplary water container for pets comprises a gravity-based water filtration system. In some embodiments, the gravity-based water filtration system is configured to allow water to percolate through the gravity-based water filtration system via gravity without being forced by a pump. In some embodiments, the water filtration system comprises an ion-exchange resin. In some embodiments, the water circulating system further comprises a controllable pump having an inlet, wherein water passes through the water filtration system toward the inlet via gravity, the water circulating system comprises one or more sensors configured to detect a speed and/or direction of the controllable pump; and the water circulating system comprises a controller configured to receive speed and/or direction data from the sensors and to selectively deactivate the controllable pump based at least in part on the speed and/or direction data.

The foregoing and other objects, features, and advantages of the disclosed technology will become more apparent from the following detailed description, which proceeds with reference to the accompanying figures.

### BRIEF DESCRIPTION OF THE DRAWINGS

FIG. 1 is a perspective view of the front of an exemplary embodiment of a water container designed according to the disclosed technology.

FIG. 2 is a perspective view of the back of the exemplary embodiment of the water container of FIG. 1.

FIG. 3 is a perspective view of the left side of the exemplary embodiment of the water container of FIG. 1

FIG. 4 is a zoomed-in view of the left side of the exemplary embodiment of the water container of FIG. 1 looking toward the right side of the water container and showing details of the pump outlet region as it joins the bowl region.

FIG. 5 is a top view of the exemplary embodiment of the water container of FIG. 1

FIG. 6 is a bottom view of the exemplary embodiment of the water container of FIG. 1.

FIG. 7 is a top view of the water container of FIG. 1 with the upper housing portion separated from the lower housing portion.

FIG. 8 is a perspective view of the left side of the upper surface of the lower housing portion of the water container of FIG. 1.

FIG. 9 is a perspective view of the left side of the bottom surface of the upper housing portion of the water container of FIG. 1.

FIG. 10 is a side view of the front side of the upper housing portion of the water container of FIG. 1.

FIG. 11 is a schematic block diagram of a pump circuit as can be used in the water container of FIG. 1.

FIG. 12 is a flow chart illustrating an exemplary process of operating the pump of the water container of FIG. 1.

FIG. 13 is a perspective view of an exemplary filtration system as can be used in the water container of FIG. 1.

FIG. 14 is a perspective view of the exemplary filtration system of FIG. 13 showing its constituent components.

FIG. 15 is an illustration showing another exemplary filtration system as can be used in the water container of FIG. 1.

FIG. 16 is a top view of the water container of FIG. 1 showing a power cord and AC/DC converter for providing power to the pump of the water container.

FIG. 17 is a top view of the water container of FIG. 1 showing a switch, AC/DC converter, and panel of solar cells as can be used to power the pump of the water container.

FIG. 18 is a top view showing a close up of the switch in FIG. 17.

FIG. 19 is a schematic diagram showing an exemplary switching circuit for controlling the switch in FIG. 17.

FIG. 20 is a flow chart showing an exemplary process for controlling the switch in FIG. 17.

FIG. 21 is a front side view of the water container of FIG. 1.

FIG. 22 is a back side view of the water container of FIG. 1.

FIG. 23 is right side view of the water container of FIG. 1.

FIG. 24 is a left side view of the water container of FIG. 1.

### DETAILED DESCRIPTION

Disclosed below are representative embodiments of methods, apparatus, and systems related to water containers for household pets that have a mechanism for and/or circulating water. The disclosed methods, apparatus, and systems should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed embodiments can be used alone or in various combinations and subcombinations with one another. The disclosed methods, apparatus, and systems are not limited to any specific aspect or feature or combination thereof, nor do the disclosed embodiments require that any one or more specific advantages be present or problems be solved. Furthermore, as used herein, the term “and/or” means any one item or combination of items in the phrase.

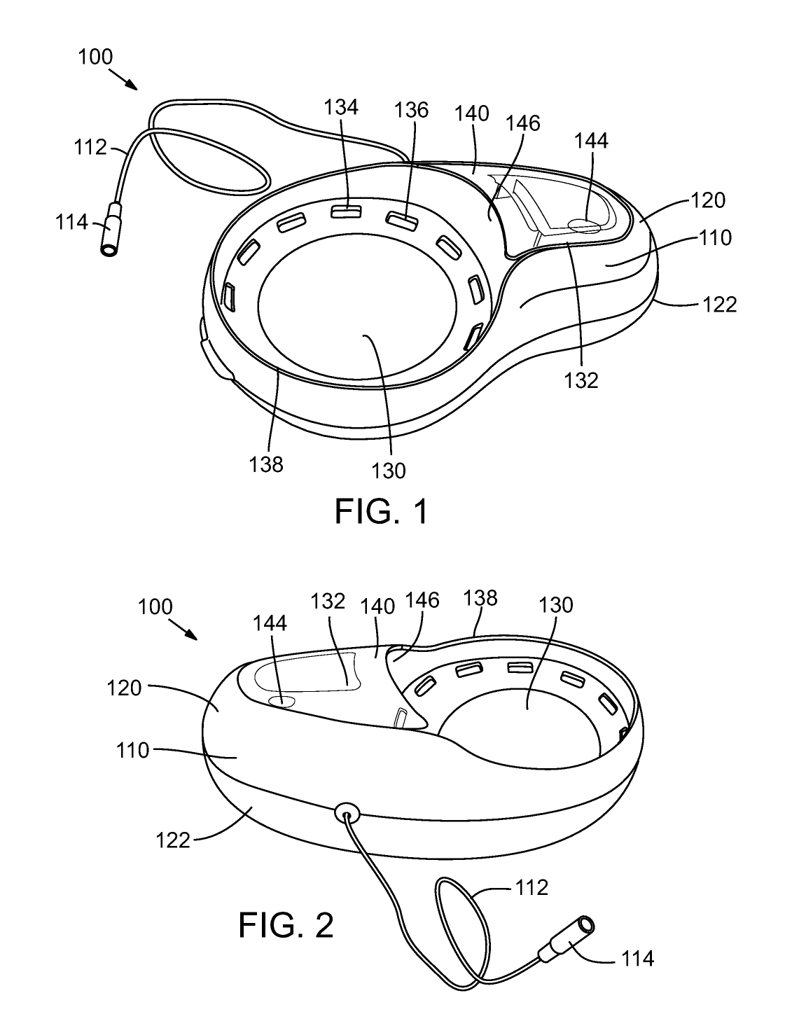

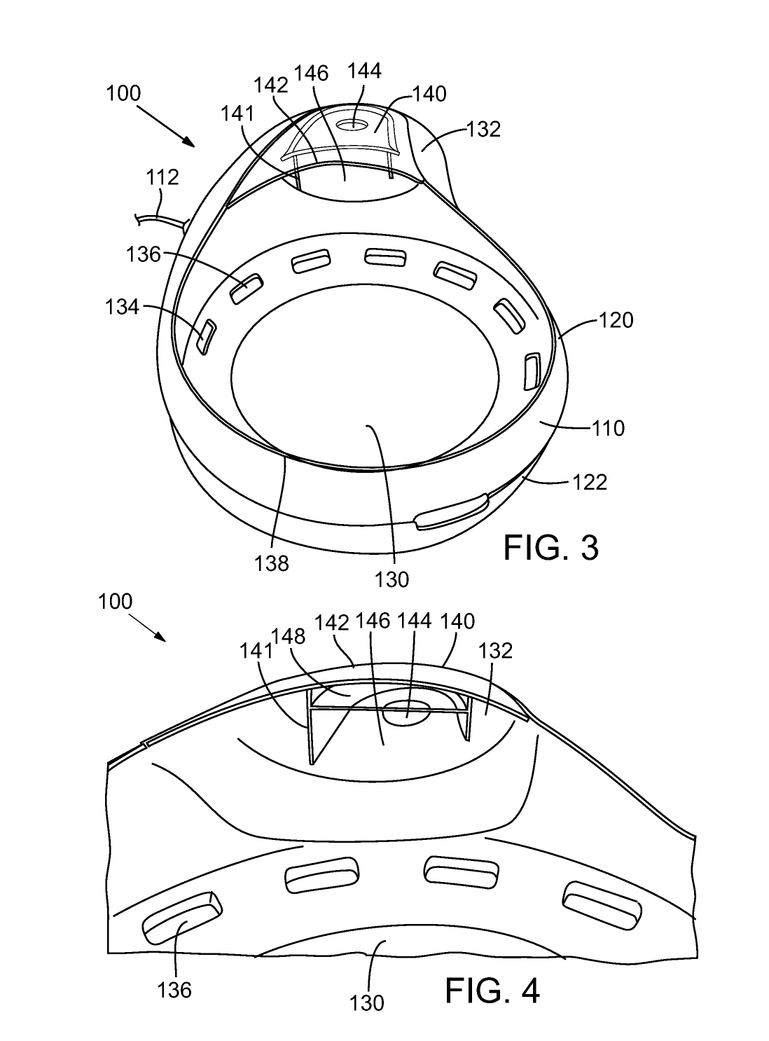

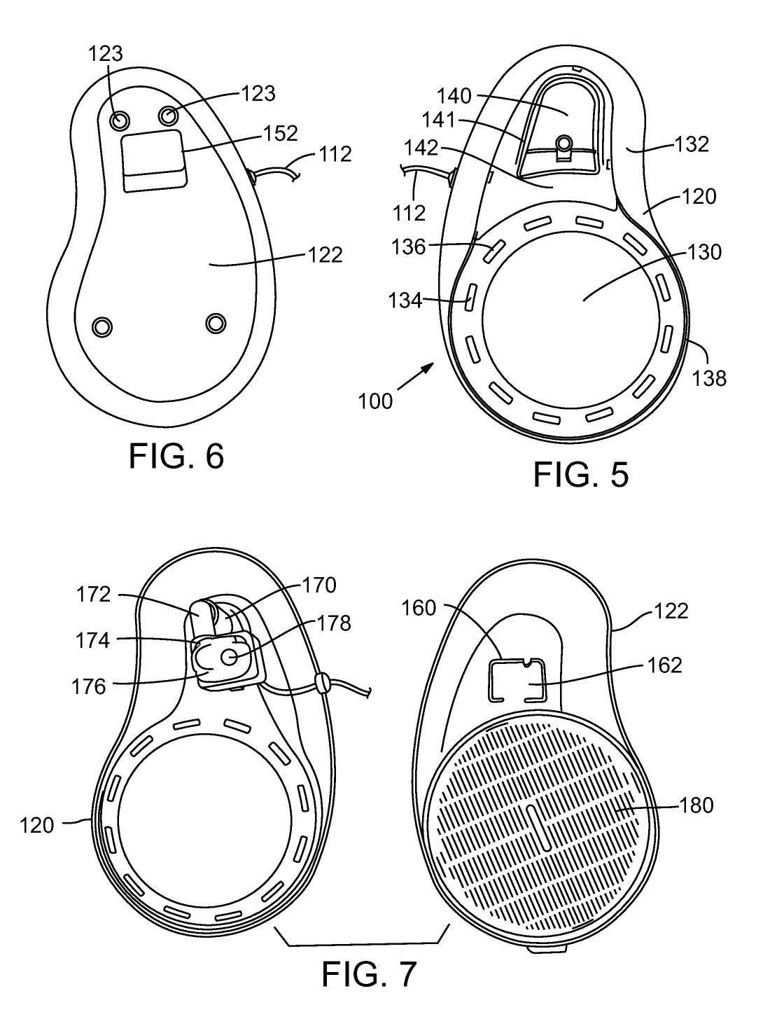

FIGS. 1-6 are various views of an exemplary embodiment of a water container 100 designed according to the disclosed technology. In particular, FIG. 1 is a perspective view of the front of an exemplary embodiment of a water container 100 designed according to the disclosed technology. FIG. 2 is a perspective view of the back of the exemplary embodiment of the water container 100. FIG. 3 is a perspective view of the left side of the exemplary embodiment of the water container 100. FIG. 4 is a zoomed-in view of the left side of the exemplary embodiment of the water container 100 looking toward the right side of the water container 100 and showing details of a pump outlet region 132 as it joins a bowl region 130. FIG. 5 is a top view of the exemplary embodiment of the water container 100. FIG. 6 is a bottom view of the exemplary embodiment of the water container 100.

As shown in FIGS. 1-6, the water container 100 comprises a main body 110 formed from an upper housing portion 120 and a lower housing portion 122. In the illustrated embodiment, the upper housing portion 120 and the lower housing portion 122 engage one another at their respective perimeter edges. The location of the perimeter edges of the upper housing portion 120 and the lower housing portion 122 can vary from implementation to implementation. For example, in the illustrated embodiment, the parting line between the upper housing portion 120 and the lower housing portion 122 is about midway along the vertical axis of the water container 100. In other implementations, the parting line is higher (e.g., at or near the top of the rim of the bowl region 130). In such embodiments, the side walls of the lower housing portion 122 are higher than in the illustrated embodiment, allowing the water level of the lower housing portion to be filled higher without any possibility of water leaking through the partition between the upper housing portion 120 and the lower housing portion 122.

In the illustrated embodiment, the main body 110 has a generally tear-drop (or kidney) shape. It is to be understood, however, that the main body 110 can have a variety of other shapes (e.g., circular, elliptical, rectangular, box-shaped, or any other shape). An upper surface of the main body 110 comprises a circular bowl region 130 and a pump outlet region 132 that is adjacent to the bowl region and has a generally tapered body relative to the bowl region 130. For example, the pump outlet region 132 is generally narrower than the bowl region 130. Further, in the illustrated embodiment, the main body 110 is generally shaped like an oval with an inward curve at one side. In general, the main body 110 can be shaped to have a low vertical profile. For instance, the main body 110 can be shaped so that the whiskers of a household pet (e.g., a cat or dog) do not brush (or otherwise engage) any vertical or other components of the water container 100 when they approach and drink water from the water container 100. Furthermore, in the illustrated embodiment, the bowl region 130 is opaque but can be formed of a translucent material that allows visibility of the water level in the water container 100.

The pump outlet region 132 includes a pump outlet aperture 144 (sometimes referred to as the “pump outlet port” or just “pump outlet”) and a channel 146 configured to transport water output from the pump outlet aperture 144 into the bowl region 130. The channel 146 includes a slight downward slope so that the water from the pump outlet aperture 144 freely flows into the bowl region 130. Further, in the illustrated embodiment, the channel 146 and the bowl region 130 are formed so that water flows into the bowl region 130 without free-falling into the bowl region 130.

A transparent member 140 (sometimes referred to as the “window member” or “see-through member”) is located above the pump outlet region 132. In certain embodiments, the transparent member 140 is formed to maintain a smoothly curved shape that maintains or substantially maintains the curved shape of the main body 110. Further, the transparent member 140 can allow a household pet (e.g., a cat) to see the water circulating in the water container 100. In particular, the transparent member 140 allows a cat to view the water being pumped through the pump outlet aperture 144 and into the channel 146.

In the illustrated embodiment, and as best seen in FIGS. 3 and 4, the transparent member 140 includes one or more vertical wall portions 141 that engages or is otherwise securably coupled to the top surface of the pump outlet region 132 and that supports a top portion 142 of the transparent member 140. In the illustrated embodiment, the transparent member 140 is shaped to help guide water output through the pump outlet aperture 144, along a channel 146 integrally formed with the pump outlet region 132, and into the bowl region 130. In particular, as water is output from the pump outlet aperture 144, the water hits the bottom surface of the top portion 142 of the transparent member 140 and is deflected into the channel 146. Further, the transparent member can include one or more baffles (such as horizontal baffle 148) to further control and regulate the water stream output from the pump outlet aperture 144. In the illustrated embodiment, the transparent member 140 is transparent and formed from a different material than the remainder of the main body 110. In other embodiments, the transparent member 140 is integrally formed into the main body 110 and/or is opaque (not transparent). In other embodiments, the transparent member 140 is absent from the water container.

The bowl region 130 is configured to receive and hold water for drinking by a household pet and is surrounded along its periphery by a lip 138 that extends to an upper edge of the upper housing portion 120. In the illustrated embodiment, the bowl region 130 and the pump outlet region 132 are integrally formed into the upper housing portion 120, but can be formed from separate pieces. Further, in the illustrated embodiment, the main body 110 can comprise one or more apertures (two of which are shown as representative apertures 134, 136) positioned circumferentially around the bowl region 130. In this arrangement, water can pass into an interior of the main body 110 and into the filter system (discussed below) at different points, thus increasing the effectiveness of the filter system. Further, the illustrated aperture placement allows water to pass to the interior of the main body 110 even if the water container 100 is tilted slightly or placed on a non-level support surface. In general, the apertures (e.g., apertures 134, 136) can be located along a lip 138 of the bowl region 130 at a location and elevation that allows a desired depth of water to be held in the bowl region 130. Any number of apertures can be located in the bowl region 130 and can be located in various positions in the bowl region 130 (e.g., on the bottom of the bowl region, on the lip of the bowl region, etc.). The apertures (e.g., apertures 134, 136) are in fluid communication with the interior of the main body 110, thus allowing passage of water from the bowl region 130 into the interior of the main body 110 and, in particular embodiments, into an interior bowl region 163 (discussed more fully below).

As best seen in FIGS. 3 and 5, the bowl region 130 of the exemplary embodiment of the water container 100 has a circular shape. This shape should not be construed as limiting, however, as the bowl region 130 can have any shape (e.g., oval, square, rectangular, polygonal, elliptical, or any other shape). Further, although the illustrated embodiment includes apertures that extend around the entire circumference of the bowl region 130, the number and location of the apertures can vary and may extend only around a portion of the bowl region 130.

The upper housing portion 120, the lower housing portion 122, the transparent member 140, and/or any of the other components described herein (e.g., the filter basket body 182, the filter basket cover 184 discussed below) can be formed from a wide variety of materials. For example, in certain embodiments, the upper housing portion 120, the lower housing portion 122, and the transparent member 140 are formed from suitably rigid materials that are durable, resistant to easy breakage or shattering, and suitably waterproof or non-dissolving. For example, the upper housing portion 120, the lower housing portion 122, and the transparent member 140 can be manufactured from a hard polymer (e.g., plastic, polyethylene, polypropylene, or other such polymers). In such cases, these components can be manufactured using one or more of a variety of techniques (e.g., injection molding). Any of the other components of the water container can also be manufactured from a suitable hard polymer. In other embodiments, other suitable materials are used to manufacture one or more of the upper housing portion 120, the lower housing portion 122, the transparent member 140, and/or any of the other components described herein (e.g., rubber, metal, chrome, and the like).

Embodiments of the water container 100 can be designed for indoor or outdoor use. For example, embodiments of the water container 100 designed for outdoor use can be manufactured using durable materials that are particularly resistant to weather and sun (e.g., UV-resistant hard polymers, metal, or the like).

As best seen in FIGS. 2 and 5, the exemplary embodiment of the water container 100 comprises a power cord 112 that extends from the main body 110 and, in the illustrated embodiment, terminates at a cord connector 114 (e.g., a female cord connector). As more fully explained below, the cord connector 114 can be used to electrically couple the exemplary embodiment of the water container 100 to a variety of power sources, including a solar power source and/or an AC power source that converts the AC power to a DC power.

As best seen in FIG. 6, the bottom surface of the lower housing portion 122 includes one or more rubber bumpers 123 that protrude from the bottom surface and provide footings for the water container 100. Further, the rubber of the rubber bumpers 123 helps prevent the water container 100 from sliding on the surface on which the water container 100 rests (e.g., a kitchen tile surface or hard wood surface). As also seen in FIG. 6, the bottom surface includes a protruding region 152 that protrudes from the bottom surface of the lower housing portion 122. As more fully explained below, the protruding region 152 defines the bottom surface of a pump receptacle 160 defined by a wall in the lower housing portion 122. Further, the bottom surface of the pump receptacle 160 is configured to have a lower surface than the remainder (or a majority) of the bottom surface of the lower housing portion 122. This creates a lower basin 162 in the lower housing portion 122 with the lowest (or near lowest) elevation. Thus, and as more fully explained below, as water is pumped from the lower housing portion 122, the lower basin 162 will hold the last remaining water in the lower housing portion 122 at a depth of just a few millimeters (e.g., 1-30 mm). Furthermore, because the impeller of the pump (e.g., pump 176) is positioned adjacent to the bottom surface of the lower basin 162, the pump 176 can effectively pump substantially all the water from the lower housing portion 122 before the impeller is exposed to air.

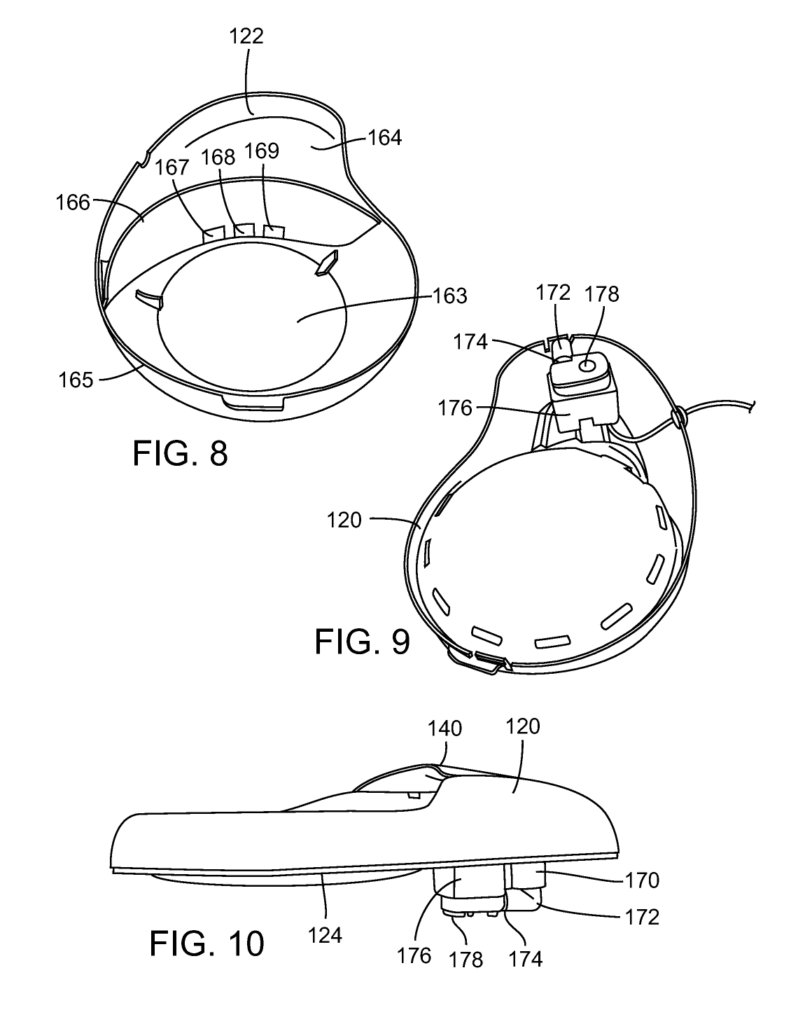

FIGS. 7-10 are various views showing additional details of the upper housing portion 120 and the lower housing portion 122. In particular, FIG. 7 is a top view of the water container 100 with the upper housing portion 120 separated from the lower housing portion 122. In particular, a bottom surface of the upper housing portion 120 and a top surface of the lower housing portion 122 are shown in FIG. 7. FIG. 8 is a perspective view of the left side of the upper surface of the lower housing portion 122. FIG. 9 is a perspective view of the left side of the bottom surface of the upper housing portion 120. FIG. 10 is a side view of the front side of the upper housing portion 120.

As best seen in FIGS. 7, 9, and 10, the bottom surface of the upper housing portion 120 includes an elongated tubular post 170 that extends from the bottom surface of the upper housing portion 120 and terminates at an end. A tubular member 172 (e.g., an L-shaped or elbow-shaped member) has a first end inserted into and in fluid communication with the end of the tubular post 170 and a second end that is in fluid communication with an output port 174 of a pump 176. The tubular member 172 can be secured to the end of the tubular post 170 and the output port 174 of the pump 176 using any suitable fastening mechanism (e.g., via a suitable adhesive or friction fit). The pump 176 further comprises an input port 178 that is located adjacent to an impeller (not visible) of the pump. In use, the impeller of the pump 176 operates to force water through the input port 178, out the output port 174, into the elbow 172, through the tubular post 170, and out the pump outlet aperture 144 on the top surface of the upper housing portion 120.

As best seen in FIG. 10, the pump 176 extends below a bottom edge 124 of the upper housing portion 120 so that at least a portion of the pump resides in the interior of the lower housing portion 122 when the upper housing portion 120 and the lower housing portion 122 are joined to one another as in FIGS. 1-6. Further, the input port 178 of the pump 176 is oriented downward toward the bottom surface of the lower housing portion 122, thus allowing the pump 176 to draw water to a lower level than if the input port were located on a side of the pump. Furthermore, the pump 176 and the input port 178 are positioned in the upper housing portion 120 so that they are suspended slightly above (e.g., 1-30 mm above) the bottom surface of the lower basin 162. Because the lower basin 162 is the lowest (or near the lowest) point in the lower housing portion 122, the pump 176 can effectively pump all or substantially all (e.g., all except for 1-50 ml) of the water from the lower housing portion 122.

In particular embodiments, the pump 176 includes a shut-off mechanism that automatically stops the pump 176 and the impeller when the pump 176 is not pumping water. For example, when the water level in the lower housing portion 122 falls beneath the input port 178 such that the input port is no longer submerged, water will no longer be pumped through the pump 176. Running the pump 176 when no water is at the input port 178 can cause the pump 176 to overheat and potentially fail (e.g., because, without water, the impeller and impeller motor operate with a much higher speed, which can cause a fuse in the pump to blow or cause a critical component to melt and damage the motor). In such instances, the pump 176 cannot be reused and is essentially destroyed. By associating a shut-off mechanism with the pump 176, the pump can be preserved and its useful life prolonged, even when the pump 176 operates in the absence of water.

In certain embodiments, the pump 176 includes a sensor, switch, and associated circuitry configured to detect a speed at which the impeller of the pump 176 is operating and to switch the pump off when the pump speed (e.g., the RPMs of the impeller or impeller rotor) exceeds a threshold rate. The threshold rate can be set so that it is exceeded when the pump 176 operates in the absence of water at its input port 178 and so that it is not exceeded when the pump 176 operates with water at its input port 178. The electrical components of the pump 176 can be enclosed in a water-proof housing associated with the pump.

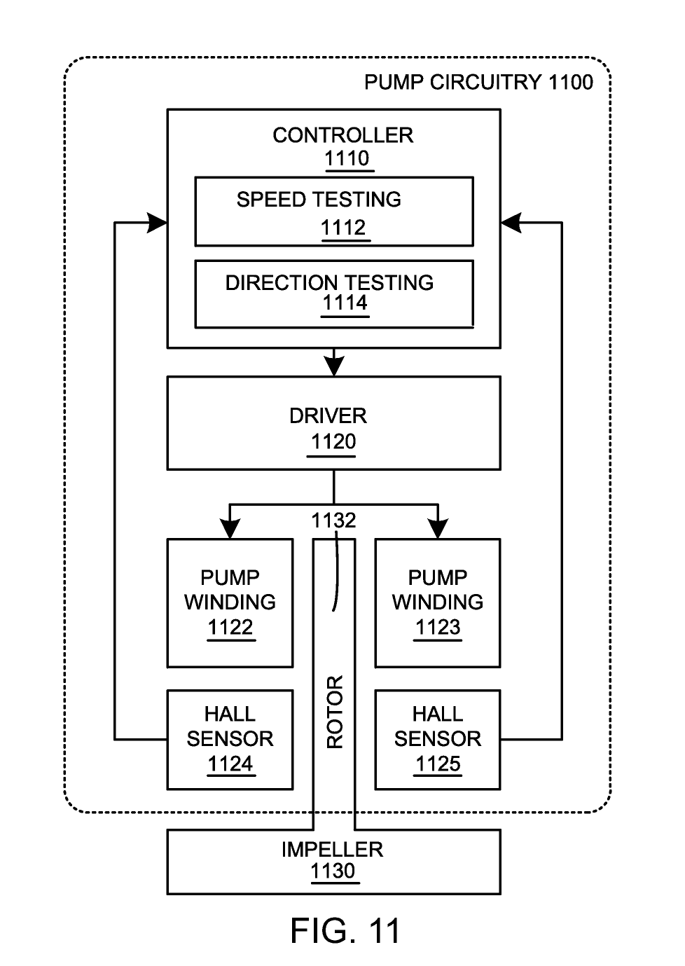

FIG. 11 is a schematic block diagram of a suitable pump circuit 1100. The pump circuit 1100 comprises one or more sensors (e.g., Hall-effect sensors 1124, 1125) configured to generate a signal as the permanent magnets associated with an impeller rotor 1132 pass in proximity to the sensors. The Hall-effect sensors can be positioned relative to one another so that the signals they generate can be interpreted to determine not only the speed at which the impeller rotor 1132 is rotating but also the direction of rotation (e.g., the Hall-effect sensors can be positioned so that they are not symmetrical with one another). The pump circuit 1100 further comprises a controller 1110, which can be a microprocessor-based or microcontroller-based controller. In other embodiments, the controller 1110 comprises other suitable electrical and/or logic components. The controller 1110 can be configured to receive the signals from the one or more Hall-effect sensors (comprising speed and direction data) and determine the speed of the impeller rotor 1132 using a speed testing process 1112 and the direction of the rotor using a direction testing process 1114. Based on this information, the controller 1110 can evaluate whether the impeller rotor 1132 and impeller 1130 are operating at an expected speed and direction (e.g., consistent with the presence of water at the input port 178) or at an unexpected speed and direction (e.g., consistent with the absence of water at the input port 178). As a result of this evaluation, the controller 1110 can generate a control signal for a driver 1120 to either continue to drive current through the pump windings (e.g., pump windings 1122, 1123) and thereby maintain pump operation, or discontinue the current and thereby deactivate the pump 176. For instance, the pump 176 can remain activated if the speed of the impeller rotor 1132 is below a threshold value and the direction of the impeller rotor 1132 is the correct direction (e.g., the direction that causes water to be pumped from the input port 178 to the output port 174).

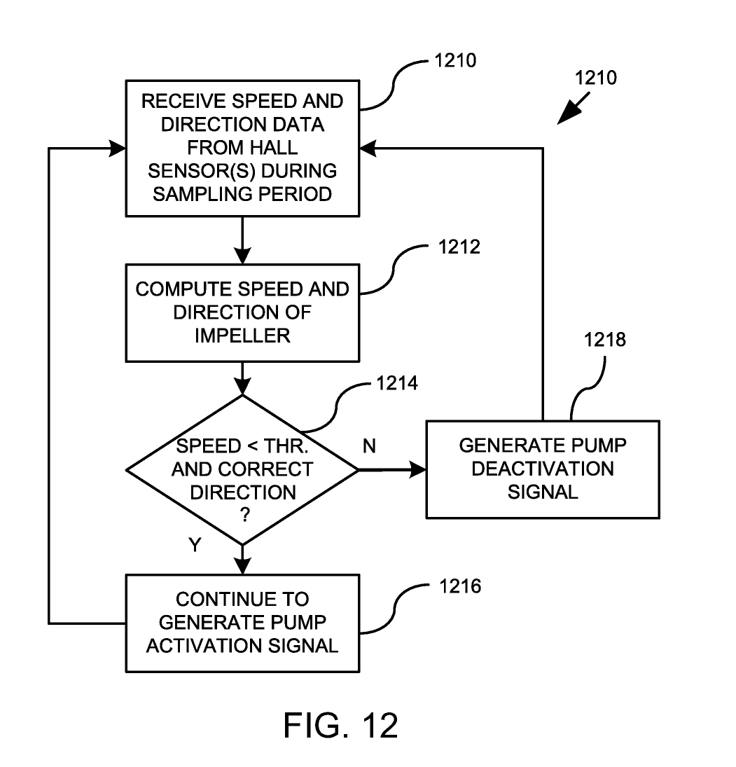

FIG. 12 is a flow chart illustrating an exemplary process 1200 of operating the pump 176 that can be performed by the controller 1110. At 1210, speed and direction data is received from one or more effect sensors (e.g., the Hall-effect sensors 1124, 1125) during a sampling period. The sampling period can vary from implementations, but in one embodiment is between 1 and 120 seconds (e.g., 5-10 seconds). At 1212, the speed and direction of the impeller 1130 is determined from the received signals. For example, the speed of the impeller 1130 can be determined from the number of signals received from the respective sensors during the sampling period, and the direction of the impeller 1130 can be determined from the relative order of the signals received from the respective sensors. At 1214, a determination is made as to whether the determined speed is less than (or less than or equal to) a threshold speed and if the determined direction is a correct direction (indicating that the impeller 1130 is pumping water to the pump output port 174). If both criteria are met, then, at 1216, the controller 1110 continues to generate a pump activation signal that drives the pump 176. If one of the criteria is not met, then at 1218 the controller 1110 generates a pump deactivation signal that causes the driver 1120 to shut off the pump 176.

In certain embodiments, the process 1200 is performed only after the pump 176 has operated for a threshold period of time (e.g., 5-10 seconds). This allows water to begin circulating through the water container 100 and allows the system to a reach a state of stable circulation before testing the whether the pump 176 should be shut off. Additionally, in some embodiments, only speed data is used to determine whether to shut off the pump 176. The direction data can be useful, however, to prevent a false reading of impeller speed when water from within the tubular post 170 drains downward through the pump 176 when the pump 176 first shuts off, causing the impeller 1130 to spin in an opposite direction. Furthermore, the direction data can be useful to prevent the impeller 1130 from restarting once the impeller 1130 stops, since a stopped impeller has a speed less than the speed threshold. Because a stopped impeller will generate no (or insufficient) signals from the Hall-effect sensors to detect direction, however, the direction criterion will not be satisfied by a stopped impeller. In certain embodiments, two speed thresholds can be used to determine pump activation. In particular embodiments, for example, two speed thresholds must be satisfied in order for the pump 176 to remain activated: a first threshold that signals when the impeller speed is too high, and a second threshold that signals when the impeller speed is too low (and consistent with the impeller 1130 being stopped). In such embodiments, the pump 176 will only continue to operate when the detected speed is between the first and the second thresholds.

The mechanisms for shutting off the pump 176 described above should not be construed as limiting, as other mechanisms can be used. For example, the water container 100 can include one or more sensors that sense the depth of the water in the interior of the lower housing portion 122 and send a shut-off signal to the pump 176 when the depth of the water is at or beneath a threshold depth. Additionally, the mechanisms for shutting off the pump 176 described above can be supplemented with further functionality. For example, in some embodiments, when the pump is deactivated, the pump may periodically reactivate (e.g., every 5 minutes, 10 minutes, 30 minutes, or some other interval) to obtain new speed and direction measurements to determine whether the pump is now submerged in sufficient water to operate. Or the pump 176 may have a restart switch that can be activated by a user or that is automatically triggered once additional water is added. In still other embodiments, the pump 176 can be restarted only by disconnecting and reconnecting its power supply.

In further embodiments, different styles of pumps or pump mechanisms are used. Indeed, any submersible pump of a suitable size can be incorporated into the water container. For example, pumps that sit on or are incorporated into the lower housing portion 122 can be used. Furthermore, the orientation of the pump impeller may vary from implementation to implementation.

Returning to FIG. 8, the lower housing portion 122 comprises an interior bowl region 163 and a pump region 164. The interior bowl region 163 is formed from a portion of the exterior wall 165 of the lower housing portion 122 and an interior lip 166. Further, as shown in FIG. 8, the interior lip 166 includes interior apertures 167, 168, 169 that allow water from the interior bowl region 163 to pass through to the pump region 164 and the lower basin 162 (shown in FIG. 7).

As best seen in FIG. 7, the interior bowl region 163 is configured to hold a filtration system, such as exemplary filtration system 180. In general, the filtration system 180 is configured to receive water passing through the apertures of the bowl region 130 or on the upper surface of the upper housing portion 120 (e.g., the apertures 134, 136) into the interior space of the interior bowl region 163. The water passing from the bowl region 130 can then percolate through the filtration system, which can include one or more filtration components and/or filter stages. Because the water is allowed to percolate through the filtration system and is urged through the system by gravity (as opposed to being pumped quickly through the filtration system), the effectiveness of the filtration system (e.g., the effectiveness of the ion-exchange resin elements and carbon elements discussed below) can be increased. The effectiveness of the filtration system is also benefited by the location of the apertures in the bowl region 130, which serve to spread the water out across a large surface area of the filtration system. Once filtered, the water can pass to the pump region 164, where it is then pumped by the pump 176 to the pump outlet aperture 144.

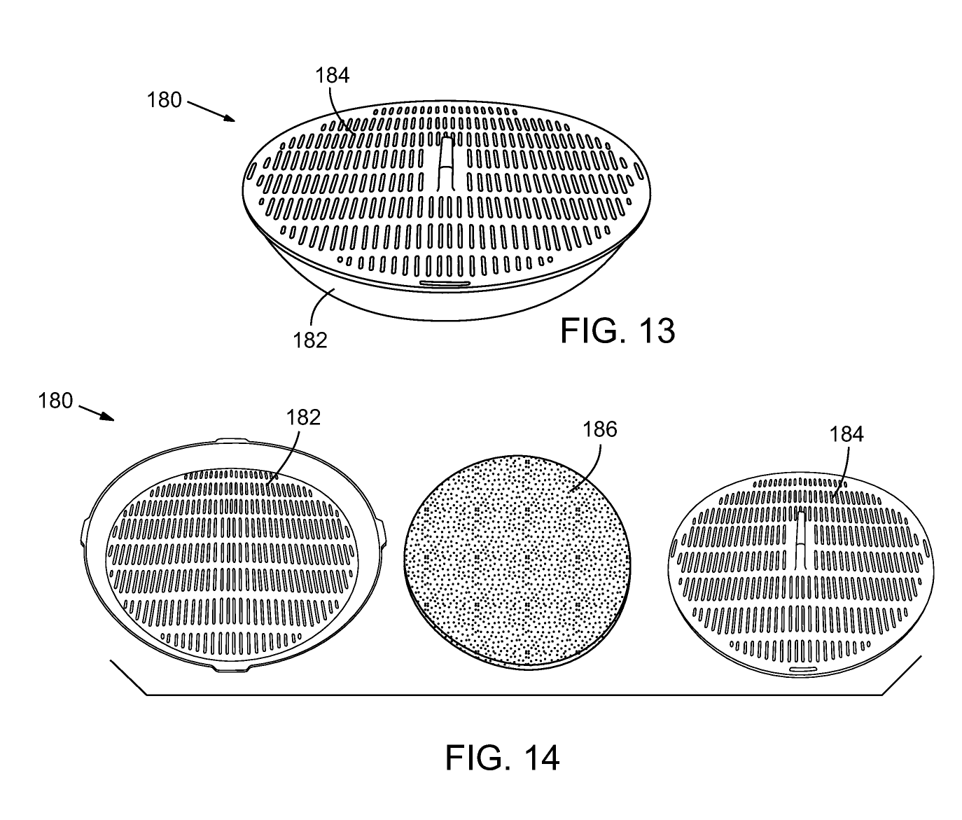

FIGS. 13 and 14 show additional details concerning the exemplary filtration system 180. In particular, FIG. 13 is a perspective view of the filtration system 180, and FIG. 14 is a perspective view of the filtration system 180 separated into its constituent components. The filtration system 180 includes a main filter basket body 182 and a filter basket cover 184. The filter basket body 182 and the filter basket cover 184 can be removably secured to one another via any suitable mechanism (e.g., a snap-fit mechanism, tongue-and-groove mechanism, or the like). Alternatively, the filter basket body 182 and the filter basket cover 184 can be coupled to one another via a hinge, or the filter basket cover 184 can rest on the filter basket body 182 without being attached. At least a portion of each of the filter basket body 182 and the filter basket cover 184 can be perforated, porous, or include one or more apertures that allow the passage of fluid. In particular embodiments, the filter basket cover 184 includes apertures sized to prevent passage of particles of a certain size (e.g., particles with a diameter of 2 mm or larger, 3 mm or larger, 4 mm or larger, or other diameter sizes). Further, the filter basket body 182 and the filter basket cover 184 define an interior filter space in which one or more replaceable filter components can be inserted. For example, in the illustrated embodiment, a puck-shaped (or disc-shaped) filter bag 186 is configured for insertion into the interior of the filter basket body 182. The filter bag 186 can be formed from a suitably porous material and can enclose one or more filtration components. For example, in particular embodiments, the filter bag 186 encloses ion-exchange resin (e.g., beads or elements of ion-exchange resin). The ion-exchange resin serves to remove undesirable ions from the water (e.g., poisonous and heavy metal ions) and exchanges them with more harmless ions. The filter bag can include one or more additional filter components. For instance, in particular embodiments, activated carbon or charcoal elements (e.g., granulated carbon or charcoal) are included within the filter bag 186. The activated carbon serves to reduce other water impurities, such as chlorine, pesticides, and/or organic contaminants. When the filter bag 186 is no longer effective in filtering water, it can be removed from the filter basket body 182 and replaced. Additional filtration components can also be part of the filtration system 180 and used with the filter basket body 182 and the filter basket cover 184. For example, a pre-filter component (e.g., a disc- or puck-shaped sponge or mesh) can be placed on top of the filter basket cover 184 and used to filter larger particles (e.g., particles with a diameter of 4 mm or larger, 5 mm or larger, or other diameters).

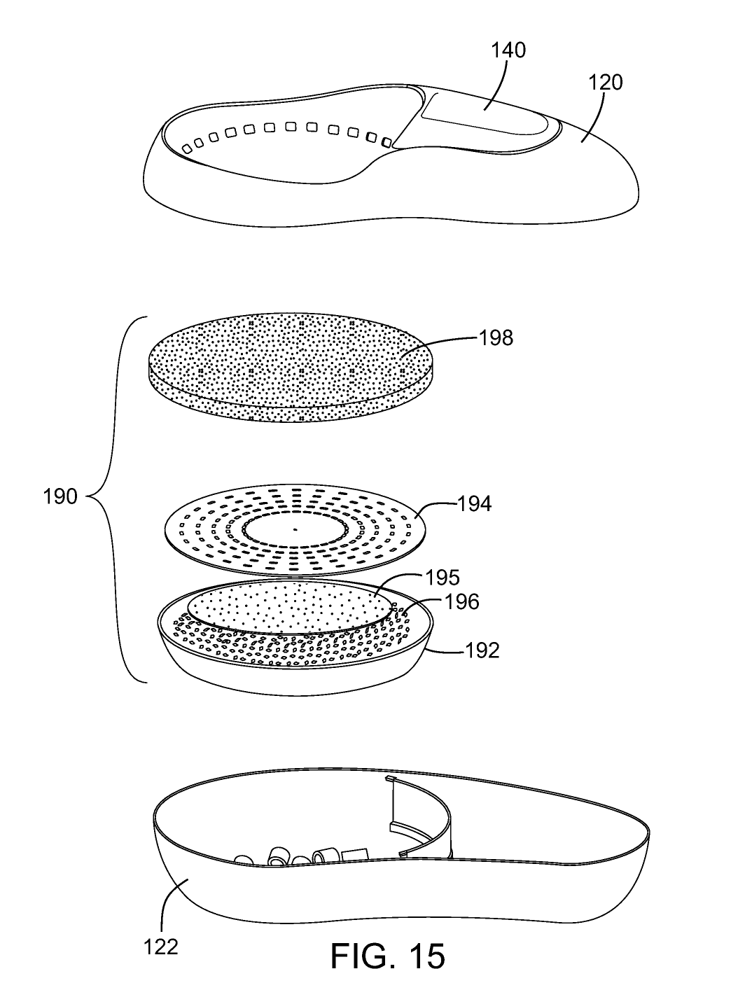

The basket-and-bag configuration illustrated in FIGS. 13 and 14 should not be construed as limiting, as the filter system in the lower housing portion 122 can comprise a wide variety of filtration components and configurations. For example, another suitable filtration system 190 similar to the filtration system 180 is shown in FIG. 15. In particular, the filtration system 190 includes a filter basket body 192 and a filter basket cover 194 that enclose one or more filtration components (e.g., ion-exchange resin 195 and granulated carbon 196). In contrast to the filter system 180, the ion-exchange resin 195 and the granulated carbon 196 are not held within a bag but are enclosed by the filter basket body 192 and the filter basket cover 194, which together form a replaceable filter basket (or frame, or filter cartridge) that can be replaced when the ion-exchange resin beads and the granulated carbon lose their effectiveness. In particular embodiments, the filter basket body 192 and the filter basket cover 194 can be attached to one another (e.g., via an adhesive, snap-fit mechanism, or other suitable attachment mechanism). Additional filtration components can also be included as part of the filtration system 190. For example, a pre-filter component 198 (e.g., a disc- or puck-shaped sponge or mesh) can be placed on top of the filter basket cover 194 to filter larger particles (e.g., particles with a diameter of 4 mm or larger, 5 mm or larger, or other diameters).

In still other embodiments, the filter system of the water container 100 can comprise additional filtering components. For example, in particular embodiments, the water container 100 can comprise a UV sterilizer that uses UV light to further purify or filter the water in the water container.

In still further embodiments, the filter system of the water container 100 has a different location and/or orientation within the water container 100. For example, instead of comprising disc-shaped components that are stacked horizontally such that the flat surfaces of the components are oriented upward and downward (as in FIG. 15), the filter and filter components can have a different shape and orientation. For instance, the filter and components can be oriented vertically in the water container 100. With reference to FIG. 8, for instance, the filter may be oriented vertically in a space in the interior lip 166, or may form at least part of the interior lip. In such configurations, the filter can be sized and shaped to fit within the water container and can at least partially form the partition between the interior bowl region 163 and the pump region 164. Such vertically oriented filters can have any one or more of the filter components discussed above (e.g., ion exchange resin or granulated carbon held inside of a frame). Furthermore, using such different locations and/or orientations for the water filter can allow for the overall shape of the water container to have greater variety. For instance, embodiments of the water container are not limited to tear-drop-shaped containers, but can have any other shape or size.

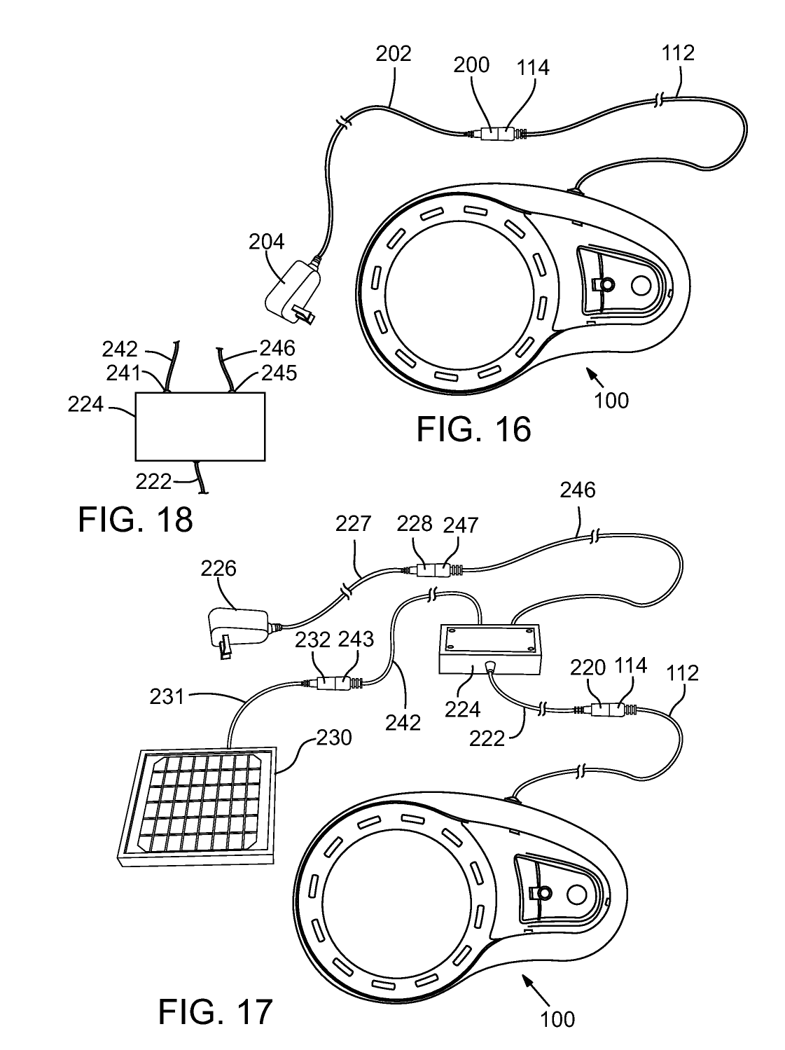

FIG. 16 is a top view of the water container 100 showing the power cord 112 and the cord connector 114 (e.g., a female cord connector). In the illustrated embodiment, the cord connector 114 is electrically coupled to a corresponding cord connector 200 (e.g., a male cord connector) of a power cord 202 powered by an AC/DC converter 204. In particular, the AC/DC converter 204 is configured to convert AC power (e.g., from an AC outlet having AC power at 100-240V) to DC power (e.g., to 12V of DC power). The use of DC power has several advantages that can be realized in one or more embodiments of the disclosed technology. One advantage that can be realized is that the use of DC power allows the water container 100 to use the same DC pump for multiple international countries, making the water container 100 more easily adapted for manufacture, sale, and use in a wide variety of countries around the world. More specifically, each country has its own power standard, which in many instances are not identical to one another. For example, North America operates using a standard of 120V at 60 Hz, Europe and many Asian countries operate using a standard of 230-240V at 50 Hz, and Japan operates using a standard of 100V at 50-60 Hz. By using a pump that operates using DC power (rather than AC power), an AC/DC converter can be used to convert an input AC signal to a common 12V DC output. Depending on the country in which the water container is to be used, the plug configuration of the AC/DC converter may change, but the converter circuitry can be the same for a wide variety of different countries and AC inputs. For instance, a single converter circuit can be used to convert power from a 100-240V AC input to a common 12V DC output. By contrast, if the pump operated using AC power, then different pumps, each adapted for a different AC power source, would need to be used, or different AC transformers would need to be included on the power cord to create the proper power supply. Such a system would add expense, weight, and unnecessary complication to the manufacturing and distribution of the water container. Another advantage that can be realized in embodiments of the disclosed technology is that the use of DC power allows the water container 100 to use a brushless DC motor in the pump. Such motors can operate more quietly, efficiently, and longer than their AC counterparts. A further advantage that can be realized is that the use of DC power allows the DC motor to receive power from other, alternative power sources. For example, and as more fully explained below, the pump 176 of the water container 100 can operate using power generated from a solar panel that produces DC power. Additionally, although the cord connector 114 in FIG. 16 is shown as being connected to a corresponding cord connector 200 of a power cord 202, the cord connector 114 can be connected to a connector located directly on the AC/DC converter itself.

FIG. 17 is a top view of the water container 100 showing the power cord 112 and the cord connector 114 (e.g., a female cord connector). In the illustrated embodiment, the cord connector 114 is electrically coupled to a corresponding cord connector 220 (e.g., a male cord connector) of a power switch power cord 222 that is output from a power switch 224. In FIG. 17, the power switch 224 is configured to receive power at two inputs from two power sources—an AC/DC converter 226 and a solar panel 230—and to select and output power to the power switch power cord 222 from one of the two power sources. The solar panel 230 is coupled to solar panel DC power cord 231, which can be coupled to the switch 224 via a first input cord 242 and a first input cord connector 243 coupled to a corresponding cord connector 232 of the solar panel DC power cord 231. The solar panel 230 can comprise a wide variety of solar cells and solar technologies. In the illustrated embodiment, the solar panel is configured to produce between 0V and 14V depending on the available light. Further, the first input cord 242 can have a sufficient length to allow the solar panel 230 to be placed on the exterior of a home while the water container 100 remains inside. In the illustrated embodiment, the AC/DC converter 226 is coupled to DC power cord 227, which can be coupled to the switch 224 via a second input cord 246 and a second input cord connector 247 coupled to a corresponding cord connector 228 of the DC power cord 227.

FIG. 18 is a top view showing a zoomed-in view of the switch 224. The switch 224 has a first input port 241 to which the first input cord 242 is coupled. As noted, the first input cord 242 is coupled to the solar panel 230 via the solar panel DC power cord 231. Further, the switch 224 has a second input port 245 to which the second input cord 246 is coupled. As noted, the second input cord 246 is coupled to the AC/DC converter 226 via the DC power cord 227.

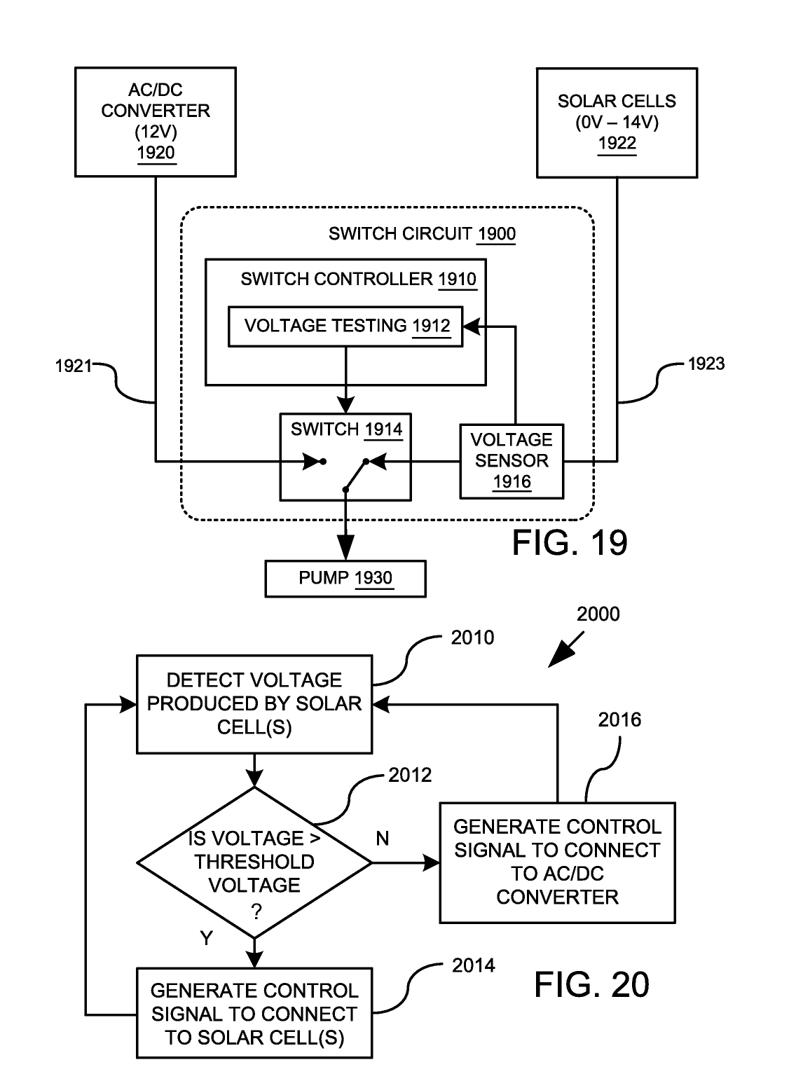

FIG. 19 is a schematic block diagram of an exemplary switch circuit 1900 for implementing the functionality of the switch 224. The illustrated switch circuit 1900 can be implemented using a variety of known electrical components. The switch circuit 1900 includes a controllable switch 1914 configured to selectively output either DC power from AC/DC converter 1920 (delivered on power line 1921 associated with the AC/DC converter 1920) or from one or more solar cells 1922 (delivered on power line 1923 associated with the solar cells 1922). The output of the switch 1914 is delivered to pump 1930, such as the pump 176 described above. The switch circuit 1900 further includes a controller 1910, which can be a microprocessor-based controller, microcontroller-based controlled, or be configured from other circuit and/or logic elements. The switch controller 1910 is configured to perform a voltage testing process 1912 that evaluates the voltage on the power line 1923 associated with the solar cells 1922 to determine whether the voltage being delivered from the solar cells 1922 is sufficient to drive the pump 1930. If the detected voltage is sufficient to drive the pump 1930, then the switch controller 1910 toggles the switch 1914 to deliver power from the solar cells 1922; otherwise, the switch controller 1910 toggles the switch 1914 to deliver power from the AC/DC converter 19120. A voltage sensor 1916 is used to measure the voltage on the power line 1923 and outputs the measured voltage to the switch controller 1910 for evaluation.

FIG. 20 is a flow chart showing an exemplary method 2000 for operating the power switch (e.g., the switch 224 or the switch 1914). At 2010, voltage produced by one or more solar cells is detected. The voltage can be detected, for example, by a voltage sensor (e.g., the voltage sensor 1916) on the power line output from the solar cells. At 2012, a determination is made as to whether the detected voltage satisfies a threshold voltage. For example, the threshold voltage can be a voltage below which the pump will not operate with the desired performance (e.g., 12V, 11V, 10V, or any other threshold voltage). If the detected voltage is greater than (or greater than and equal to) the threshold voltage, then a control signal is generated at 2014 that causes the switch to connect to the solar cells, thus delivering power to the pump from the one or more solar cells. If the detected voltage is less than or equal to (or less than) the threshold voltage, then a control signal is generated at 2016 that causes the switch to connect to the AC/DC converter. By using the process 2000, the pump can operate reliably under any lighting condition but can draw power from the solar cells when possible.

In other embodiments, the pump 176 of the water container 100 is coupled only to one or more solar cells. For example, and with reference to the components shown in FIG. 17, the power cord 112 can be coupled only to the solar panel 230 via the cord connectors 114, 232.

In still further embodiments, the pump 176 of the water container 100 can be coupled to another a DC power source. For instance, a cigarette lighter adapter can be used to provide DC power to the pump 176. With such an adapter, the water container 100 can be used in mobile environments (e.g., campers, RVs, motor homes, other motor vehicles, and the like).

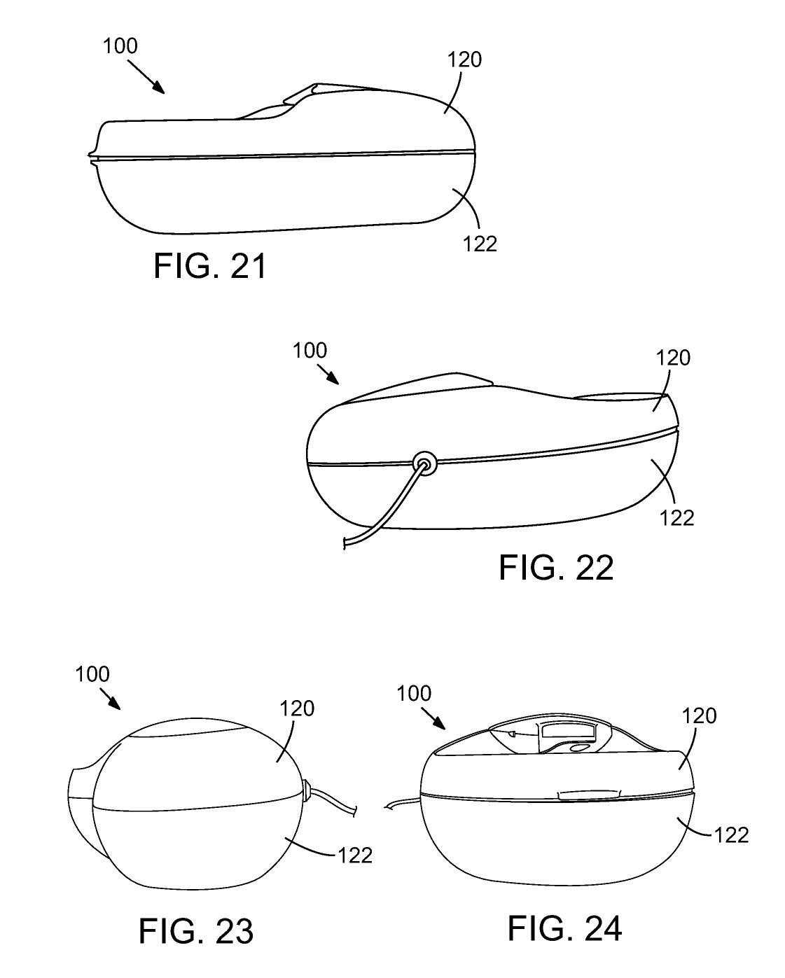

FIGS. 21-24 show additional views of the exemplary water container 100. In particular, FIG. 21 is a front side view of the water container 100, FIG. 22 is a back side view of the water container 100, FIG. 23 is right side view of the water container 100, and FIG. 24 is a left side view of the water container 100.

The size of the water container 100 can vary from implementation to implementation and can depend, for example, on the animal for which it is designed. In certain embodiments, for example, the water container 100 has an overall height of between 7 and 16 cm (e.g., at or about 11.5 cm), with the lower housing portion 122 having a height of between 4 and 8 cm (e.g., at or about 6 cm), the upper housing portion 120 having a height (at its highest) of between 3 and 6 cm (e.g., at or about 4.5 cm), and the transparent member having a height of between 0.5 and 2.5 cm (e.g., at or about 1 cm). Further, in certain embodiments, the water container 100 has a length (measured from the left side edge to the right side edge of the water container 100 (shown from left to right in FIG. 21)) of between 20 and 40 cm (e.g., at or about 30 cm), and a width (measured from the front side edge to the back side edge of the water container 100 (shown from left to right in FIG. 23) of between 14 and 24 cm (e.g., at or about 19 or 20 cm). Moreover, the diameters of the bowl region 130 and the interior bowl region 163 can also vary from implementation to implementation. In certain embodiments, for example, the diameter of the bowl region 130 is between 10 and 22 cm, such as between 14 and 19 cm (e.g., at or about 16.5 cm), and the diameter of the interior bowl region 163 is slightly larger and between 9 and 23 cm, such as between 13 and 20 cm (e.g., at or about 17.5 cm). The depth (or height) of the bowl region 130 can also vary, and in some embodiments is between 1.5 and 5 cm (e.g., at or about 3 cm), while the depth (or height) of the interior bowl region 163 is between 2 and 8 cm (e.g., at or about 5 cm).

Having described and illustrated the principles of our innovations in the detailed description and accompanying drawings, it will be recognized that the various embodiments can be modified in arrangement and detail without departing from such principles. For example, the pump of the water container can be selectively activated based on the proximate presence of a household pet. In particular embodiments, for instance, the pump can be configured to receive an activation signal from an RF ID sensor that detects when a household pet wearing a collar with an authorized RF ID tag (e.g., an active RF ID transmitter or a passive RF ID tag) is in proximity of the water container. In one example, the container 100 can comprise an RF ID transmitter that sends an RF signal to an area around the container such that when an passive RF ID tag enters the area the pump turns on.

In view of the many possible embodiments to which the principles of the disclosed technology may be applied, it should be recognized that the illustrated embodiments are only preferred examples of the disclosed technology and should not be taken as limiting the scope of the invention(s). Rather, the scope of the invention(s) is defined by the following claims. We therefore claim as our invention(s) all that comes within the scope and spirit of these claims and their equivalents.

We claim:

1. A water container for pets, comprising:
a main body having an upper surface, a lower surface, and an interior region between the upper surface and the lower surface;
a bowl region on the upper surface of the water container, the bowl region comprising one or more apertures in fluid communication with the interior region;
a pump outlet region on the upper surface of the water container, the pump outlet region comprising a pump outlet aperture, the pump outlet region being located adjacent to the bowl region and joined to the bowl region by a channel configured to transport fluid from the pump output aperture into the bowl region; and
a water circulating system, the water circulating system comprising a pump configured to pump water from the interior region of the water container to the pump outlet aperture, the water circulating system being configured to automatically deactivate when a volume of water in the interior region of the water container is insufficient to circulate using the water circulating system.

2. The water container of claim 1, wherein the water circulating system is selectively powered by two or more power sources, one of the power sources being a solar power source.

3. The water container of claim 1, wherein the pump comprises a DC pump.

4. The water container of claim 1, wherein the water circulating system comprises:
one or more sensors configured to detect a speed and/or direction of the pump; and
a controller configured to receive speed and/or direction data from the sensors and to selectively deactivate the pump based at least in part on the speed and/or direction data.

5. The water container of claim 1, further comprising a water filtration system that comprises one or more ion-exchange resin elements.

6. The water container of claim 1, further comprising a gravity-based water filtration system positioned in the interior region and below the bowl region, wherein the gravity-based water filtration system is configured to allow water to percolate through the gravity-based water filtration system via gravity without being forced by a pump.

7. The water container of claim 1, further comprising a first RF ID device configured to activate the water circulation system when a second RF ID device comes within a predetermined range of the first RF ID device.

8. A water container for pets comprising a water circulating system, the water circulating system comprising a DC pump.

9. The water container of claim 8, wherein an input port of the DC pump is oriented so that the input port faces toward a bottom of the water container, and wherein the water circulating system is configured to automatically deactivate when the input port is not submerged in water.

10. The water container of claim 8, wherein water circulating system is selectively powered by two or more power sources, one of the power sources being a solar power source.

11. The water container of claim 8, further comprising one or more sensors configured to detect a speed of the DC pump, and a controller configured to receive speed data from the sensors and to selectively deactivate the DC pump based at least in part on the speed data.

12. The water container of claim 8, further comprising a first RF ID device configured to activate the DC pump when a second RF ID device comes within a predetermined range of the first RF ID device.

13. A water container for pets comprising a water circulating system that is selectively powered by two or more power sources that are simultaneously coupled to the water container.

14. The water container of claim 13, wherein one of the two or more power sources comprises a solar power source and another of the two or more power sources comprise an AC/DC converter or a DC adapter.

15. A system comprising:
a first power source;
a second power source; and
a switch configured to receive power from the first power source and the second power source, and to selectively route power from a selected one of the first power source or the second power source to a water circulating system of a water container for pets.

16. The system of claim 15, wherein the switch is configured to selectively route the power based on a voltage level of power from at least one of the first power source or the second power source.

17. The system of claim 15, wherein the power routed to the water circulating system is DC power.

18. The system of claim 15, wherein at least one of the first power source or the second power source comprises one or more solar cells.

19. A water container for pets comprising a water filtration system that comprises one or more ion-exchange resin elements.

20. The water container of claim 19, wherein the water filtration system further comprises one or more of carbon elements, a UV filter, sponge filter, or a filter cover comprising one or more apertures configured to filter particles having a selected diameter.

21. The water container of claim 19, wherein water percolates through the filtration system via gravity without being forced by a pump.

22. A water container for pets comprising a gravity-based water filtration system.

23. The water container of claim 22, wherein the gravity-based water filtration system is configured to allow water to percolate through the gravity-based water filtration system via gravity without being forced by a pump.

24. The water container of claim 22, wherein the water filtration system comprises an ion-exchange resin.

25. The water container of claim 22, wherein the water circulating system further comprises:
a controllable pump having an inlet, wherein water passes through the water filtration system toward the inlet via gravity;
one or more sensors configured to detect a speed and/or direction of the controllable pump; and
a controller configured to receive speed and/or direction data from the sensors and to selectively deactivate the controllable pump based at least in part on the speed and/or direction data.
